(19) United States
(12) Patent Application Publication
(10) Pub. No.: US 2006/0174066 A1
(43) Pub. Date: Aug. 3, 2006

(54) Fractional-word writable architected register for direct accumulation of misaligned data

(76) Inventors: Jeffrey Todd Bridges, Raleigh, NC (US); Victor Roberts Augsburg, Cary, NC (US); James Norris Dieffenderfer, Apex, NC (US); Thomas Andrew Sartorius, Raleigh, NC (US)

Correspondence Address: QUALCOMM, INC, 5775 MOREHOUSE DR., SAN DIEGO, CA, 92121, US

(21) Appl. No.: 11/051,037

(22) Filed: Feb. 3, 2005

(51) Int. Cl. G06F 12/00

(52) U.S. Cl. 711/125

(57) ABSTRACT

One or more architected registers in a processor are fractional-word writable, and data from plural misaligned memory access operations are assembled directly in an architected register, without first assembling the data in a fractional-word writable, non-architected register and then transferring it to the architected register. In embodiments where a general-purpose register file utilizes register renaming or a reorder buffer, data from plural misaligned memory access operations are assembled directly in a fractional-word writable architected register, without the need to fully exception check both misaligned memory access operations before performing the first memory access operation.

### BACKGROUND

The present invention relates generally to the field of processors and in particular to a processor having one or more fractional-word writable architected registers for direct accumulation of misaligned data.

Microprocessors perform computational tasks in a wide variety of applications, including embedded applications such as portable electronic devices. The ever-increasing feature set and enhanced functionality of such devices requires ever more computationally powerful processors, to provide additional functionality via software. Another trend of portable electronic devices is an ever-shrinking form factor. A major impact of this trend is the decreasing size of batteries used to power the processor and other electronics in the device, making power efficiency a major design goal. The shrinking size of portable electronic devices also requires the processor and other electronics to be highly integrated and tightly packaged, placing a premium on chip area. Hence, processor improvements that increase execution speed, reduce power consumption and/or decrease chip size are desirable for portable electronic device processors.

A processor architecture is defined by its instruction set. Characteristics of modern Reduced Instruction Set Computing (RISC) architectures include relatively few instructions, segregation of memory access operations and logical/arithmetic operations among instructions, and a migration of computational complexity from the instruction set (or microcode) to the compiler. RISC hardware characteristics include one or more high-speed execution pipelines comprising a succession of relatively simple execution stages, a memory hierarchy, and an architected set of general-purpose registers (GPRs). The GPRs are all of the same width (the word width of the architecture), form the top (fastest) level of the memory hierarchy, and serve as the sources of instruction operands or addresses and the destination for instruction results. In particular implementations, a wide variety of non-architected support hardware may be provided to assist the processor, such as “scratch” registers, buffers, stacks, FIFOs and the like, as well known by those of skill in the art. Programs executed on the processor have no knowledge of these non-architected structures.

One known non-architected “scratch” register is a byte-writable register used to accumulate misaligned data from memory accesses, prior to loading the accumulated data word into an architected register. Misaligned data are those that, as they are stored in memory, cross a predetermined memory boundary, such as a word or half-word boundary. Due to the way memory is logically structured and addressed, and physically coupled to a memory bus, data that cross a memory boundary cannot be read or written in a single cycle. Rather, two successive bus cycles are required—one to read or write the data on one side of the boundary, and another to read or write the remaining data.

This requires an unaligned memory access instruction, such as a load, to generate an additional instruction step, or micro-operation, in the pipeline to perform the additional memory access required by the unaligned data. Consequently, data from the load instruction is returned in two, partial- or fractional-word pieces, and must be accumulated into a word prior to being written into an architected register such as a GPR. This may be accomplished by writing the fractional-word data from the first and second memory access micro-operations into a scratch register, each byte of which may be independently written without altering the contents of any other byte. When the last arriving fractional-word datum is written into the byte-writable scratch register, the accumulated word is written to the load instruction's destination GPR.

High-performance processors attempt to perform other memory accesses if an ongoing memory access operation incurs a long latency. While the byte-writable scratch register suffices for accumulating fractional-word data for occasional, isolated misaligned memory accesses, if a second misaligned memory accesses instruction is encountered, the byte-writable scratch register becomes a contested resource. This creates a structural pipeline hazard, as illustrated by the following example.

Data at the following address ranges are resident and available in a data cache: 0x00-0x0F, 0x20-0x2F, and 0x30-0x3F. Data in the range 0x10-0x1F are not in the cache. A first LDW (load word) instruction has a (misaligned) target address of 0x0F. This instruction will perform a memory access operation to retrieve a first byte at 0x0F from the cache, and load it into the byte-writable scratch register. The instruction will generate a second memory access operation, this time to 0x10 (to retrieve the three bytes at 0x10, 0x11 and 0x12, assuming a 32-bit word size). The second memory access will miss in the cache, requiring an access from main memory, which may incur a significant latency.

To prevent the entire pipeline from being idle pending the main memory access, the processor may launch a second LDW instruction, this one to 0x2E, which is also a misaligned data address. The second LDW instruction will generate two memory accesses—a first access to 0x2E for two bytes and a second access to 0x30 for two bytes. Both of these accesses will hit in the cache, and the data may be assembled in a byte-writable scratch register and loaded into the instruction's target GPR prior to the completion of the first LDW instruction. However, the second LDW cannot utilize the same byte-writable scratch register as the first LDW instruction, since the 0x0F byte was stored there by the first misaligned LDW instruction.

With only one byte-writable scratch register available, the pipeline controller must perform a structural hazard check prior to launching the second LDW, and prevent executing it if the resource is in use. This hazard check increases control logic complexity and processor power consumption, and adversely impacts performance. Alternatively, multiple byte-writable scratch registers may be provided. This wastes power and silicon area, since misaligned memory accesses are relatively rare occurrences. Furthermore, in either case, the need to assemble the fractional-word data into a word prior to loading it into an architected register imposes a delay on the memory access instruction, adversely impacting performance.

### SUMMARY

Architected registers in a processor are fractional-word writable, and data from misaligned memory access operations is assembled directly in an architected register, without first assembling the data in a fractional-word writable, non-architected register and then transferring it to the architected register.

In one embodiment, a method of assembling data from a misaligned memory access directly into a fractional-word writable architected register comprises performing a first memory access operation and writing a first fractional-word datum to the architected register. The method further comprises performing a second memory access operation and writing a second fractional-word datum to the architected register.

In another embodiment, a processor includes at least one fractional-word writable architected register. The processor also includes an instruction execution pipeline operative to perform two memory access operations to access misaligned data, each memory access operation writing fractional-word data directly in the fractional-word writable architected GPR register.

### BRIEF DESCRIPTION OF DRAWINGS

FIG. 1 is a functional block diagram of a processor.

FIG. 2 is a flow diagram.

### DETAILED DESCRIPTION

As used herein, the following terms have the following definitions:

Architected register: a data storage register defined (explicitly or implicitly) by the processor instruction set. Architected registers are the width of the architected word size. Instructions access architected registers for operands and memory address, and instructions write results to architected registers. Note that architected registers need not be statically defined or identified (i.e., they may be re-namable), and need not comprise clocked, static registers in hardware (i.e., they may be in a buffer, FIFO or other memory structure). General-purpose registers (GPRs), whether denominated as such or not by the instruction set architecture, are architected registers. As used herein, the term “architected register” also includes storage locations that are dynamically assigned GPR identifiers, as discussed more fully herein.

Non-architected register: a data storage register in a given implementation that is not defined or recognized by the processor instruction set. Scratch registers and pipe stage registers in the pipeline are examples of non-architected registers.

Word: the architected word size, or word width, is the atomic quantum of data recognized by the processor instruction set. Instructions read and write registers with word-width data. Modern RISC processors often have a 32- or 64-bit word width, although this is not a limitation on the present invention.

Fractional-word: a quantum of data less than the architected word width. For example, data from one to three bytes are all fractional-word quanta for a 32-bit word size.

Fractional-word writable: a data storage location to which less than a full word of data may be written without altering or corrupting other data in the register. For example, a 32-bit register with four independent byte enables is a fractional-word writable register for a 32-bit word size. Fractional-word writeability may be simulated by an appropriate read-modify-write operation performed on a word writable register; as used herein, such a register is not fractional-word writable.

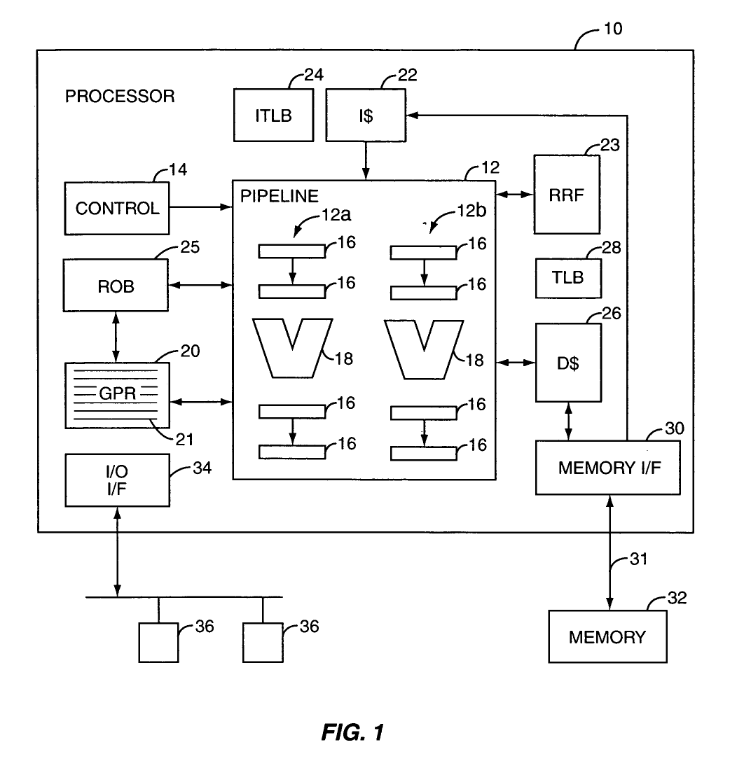

FIG. 1 depicts a functional block diagram of a processor 10. The processor 10 executes instructions in an instruction execution pipeline 12 according to control logic 14. The pipeline 12 may be a superscalar design, with multiple parallel pipelines such as 12a and 12b. The pipelines 12a, 12b include various non-architected registers or latches 16, organized in pipe stages, and one or more Arithmetic Logic Units (ALU) 18. A General Purpose Register (GPR) file 20 provides a plurality of architected registers 21, also known as GPRs 21, comprising the top of the memory hierarchy. In some embodiments, the GPR file 20 may comprise a Register Renaming File (RRF) 23. In other embodiments, a Re-order Buffer (ROB) 25 may communicate with the GPR file 20.

The pipelines 12a, 12b fetch instructions from an Instruction Cache (I-Cache) 22, with memory addressing and permissions managed by an Instruction-side Translation Lookaside Buffer (ITLB) 24. Data is accessed from a Data Cache (D-Cache) 26, with memory addressing and permissions managed by a main Translation Lookaside Buffer (TLB) 28. In various embodiments, the ITLB may comprise a copy of part of the TLB. Alternatively, the ITLB and TLB may be integrated. Similarly, in various embodiments of the processor 10, the I-cache 22 and D-cache 26 may be integrated, or unified. Misses in the I-cache 22 and/or the D-cache 26 cause an access to main (off-chip) memory 32, under the control of a memory interface 30. The processor 10 may include an Input/Output (I/O) interface 34, controlling access to various peripheral devices 36. Those of skill in the art will recognize that numerous variations of the processor 10 are possible. For example, the processor 10 may include a second-level (L2) cache for either or both the I and D caches. In addition, one or more of the functional blocks depicted in the processor 10 may be omitted from a particular embodiment.

In one or more embodiments, one or more of the architected registers 21 are fractional-word writable, and data from misaligned memory access operations is assembled directly in an fractional-word writable, architected register 21 without first assembling the data in a fractional-word writable, non-architected register and then transferring it to the architected register 21. This eliminates the silicon area and power consumption of one or more fractional-word writable, non-architected registers. It additionally eliminates the complexity associated with performing a structural hazard check to ensure that a fractional-word writable, non-architected register is available prior to initiating a misaligned memory access. Furthermore, performance is improved as the transfer of assembled word data from a fractional-word writable, non-architected register to an architected register 21 is eliminated.

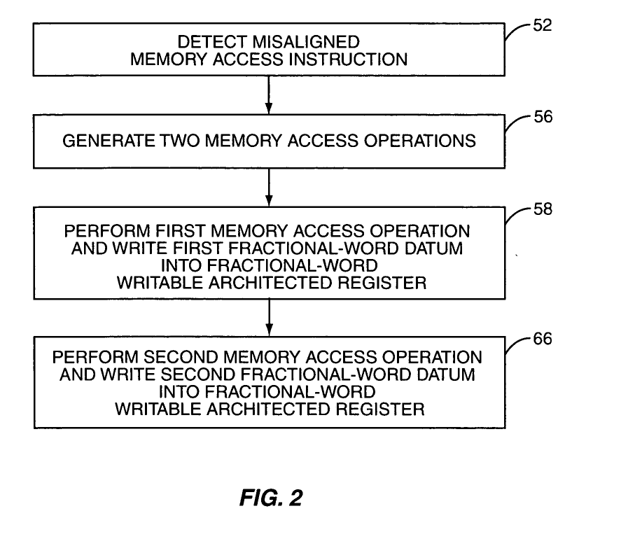

FIG. 2 depicts a method of assembling fractional-word data from a misaligned memory access instruction. A misaligned memory access instruction is detected (block 40). This may be at a decode stage, if the target address is explicit or known. Alternatively, a memory access instruction may be decoded, and the fact that it directed to misaligned data only discovered at an address generation step, deep in an execution pipeline 12a, 12b. In either case, two distinct memory access operations must be generated from the memory access instruction (block 42). A first memory access operation is performed, returning a first fractional-word datum. This fractional-word datum is written directly into a fractional-word writable architected register 21 (at a position determined by the address and the endian-ness of the processor) (block 44). A second memory access operation is then performed, returning a second fractional-word datum, which is subsequently loaded into the remaining fractional portion of the fractional-word writable, architected register 21, without altering the data written from the first memory access operation (block 46).

Preferably, both memory access operations should be exception-checked prior to launching the first memory access operation. This preserves the state of the architected register 21 for error recovery in the event that one of the memory access operations causes an exception. Preferably, the exception checking should be performed for both memory access operations in advance. For example, a LDW to a misaligned memory address will generate a first memory access operation to read part of the misaligned data. This first memory access operation may read the last byte or bytes on a memory page, and load them into the architected register 21.

A second memory access operation is required to read the remaining unaligned data. However, if the misaligned word crosses a page boundary, one or more of the remaining bytes will be in a subsequent memory page, for which the process may not have read permission. This will cause an exception; however, the contents of the architected register 21 have already been altered by the first memory access operation, and the processor's state cannot be restored by flushing the LDW and subsequent instructions. Thus, both memory access operations required by a misaligned memory access instruction are preferably exception-checked prior to performing the first memory access operation.

In one embodiment, this advance exception checking for both memory access operations is not required, where the processor includes a Register Renaming File 23. As well known in the art, register renaming is a register management method whereby a plurality of physical registers, larger than the architected number of GPRs 21, is provided. The physical registers are dynamically assigned a logical identifier corresponding to a GPR 21. Thus, for example, fractional-word data from multiple accesses to misaligned data may be assembled in a “free” physical register, and when the full word has been assembled, the register is assigned a GPR identifier.

According to one or more embodiments, the register renaming system includes the ability to recover from exceptions caused by one or more misaligned memory accesses by “undoing” the renaming operation—that is, by reassigning a GPR identifier to a physical register previously associated with that identifier. Physical registers that are renamed are not freed for reuse until the instruction associated with the renaming commits (meaning it, and all instructions ahead of it, have been fully exception-checked and are assured of completing execution). Thus, the data previously associated with the GPR identifier may be restored in the event of an exception caused by one or more misaligned memory accesses, and the processor state may be recovered by flushing the misaligned memory access instruction and all following instructions.

As misaligned data are assembled in a free physical fractional-word writable register, if an exception occurs during the second memory access operation, the physical register is not renamed, or assigned a GPR identifier. Alternatively, if already renamed, register renaming may be “undone,” by assigning the GPR identifier back to the physical register previously associated with that identifier. Thus, in renaming register embodiments, both memory access operations associated with a misaligned LD instruction need not be fully exception-checked prior to initiating the first misaligned memory access operation.

Similarly, fractional-word assembly in an architected register according to another embodiment is well suited for use in processors having a reorder buffer 25. As well known in the art, a reorder buffer 25 comprises temporary word-width storage space, arranged for example as a FIFO. Temporary or contingent instruction results may be written to the reorder buffer 25, and the buffer location then assigned a GPR identifier. When the corresponding instruction commits, the data may be transferred from the reorder buffer 25 into the architected GPR file 20. The reorder buffer 25 may be accessed in parallel with the GPR file 20, and data may be provided to an instruction from a reorder buffer location. Hence, the reorder buffer locations may be considered architected registers 21, as they provide operands and/or addresses to instructions.

In one or more embodiments, the reorder buffer 25 includes control hardware such that, if an exception occurs, the data written to a reorder buffer location may be invalidated, and/or the location may be “unnamed,” or disassociated with a corresponding GPR identifier. In particular, where the reorder buffer data storage locations are fractional-word writable, a misaligned fractional-word datum may be written to a reorder buffer location as a first memory access operation retrieves it. A subsequently retrieved misaligned fractional-word datum may then be written to the remaining portion of the reorder buffer location, and a GPR identifier assigned to it. When the LD instruction commits, the data may be transferred to the corresponding GPR 21 in the GPR file 20.

If an exception occurs during the second memory access operation, the reorder buffer location may be invalidated and/or its GPR identifier removed or disassociated. Correspondingly, the previous storage location associated with the relevant architected register number—whether in the reorder buffer 25 or the GPR file 20—may be renamed, or associated with the GPR identifier. By flushing the LD and all following instructions, the processor may be restored to the state that existed prior to the LD instruction exception. Hence, misaligned data may be fractional-word assembled directly in an architected register, without requiring that both misaligned memory access operations be fully exception-checked prior to initiating the first memory access operation.

According to various embodiments disclosed herein, a plurality of misaligned memory access instructions may be simultaneously or successively executed without performing a structural hazard check for use of one or more non-architected, fractional-word writable, “scratch” registers. This reduces complexity, improves performance, and reduces power consumption. Furthermore, a large plurality of such non-architected, fractional-word writable, scratch registers need not be provided to allow for such functionality, thus decreasing silicon area. Particularly in the case of register renaming and re-order buffers, existing logic may be utilized to recover from exceptions, obviating the need to fully exception-check both of the memory access operations required to retrieve misaligned data from memory. In all cases, the assembled data from the misaligned memory access instruction are available at least one cycle earlier than would be the case if the data were assembled in a non-architected, fractional-word writable, scratch registers and subsequently transferred to an architected register.

Although embodiments have been described herein with respect to particular features, aspects and embodiments thereof, it will be apparent that numerous variations, modifications, and other embodiments are possible within the broad scope of the present invention, and accordingly, all variations, modifications and embodiments are to be regarded as being within the scope of the invention. The present embodiments are therefore to be construed in all aspects as illustrative and not restrictive and all changes coming within the meaning and equivalency range of the appended claims are intended to be embraced therein.

What is claimed is:

1. A method of assembling data from a misaligned memory access directly into a fractional-word writable architected register, comprising:
performing a first memory access operation and writing a first fractional-word datum to said architected register; and
performing a second memory access operation and writing a second fractional-word datum to said architected register.

2. The method of claim 1 further comprising exception-checking both said memory access operations prior to writing said first fractional-word datum to said architected register.

3. The method of claim 1 further comprising exception-checking each said memory access operation.

4. The method of claim 3 wherein said fractional-word writable architected register comprises a physical register in a register renaming file, and further comprising renaming said physical register by assigning it a general-purpose register (GPR) identifier.

5. The method of claim 4, wherein said renaming step is performed if said second memory access operation does not cause an exception.

6. The method of claim 4 further comprising removing said GPR identifier from said physical register if either said memory access operation causes an exception.

7. The method of claim 3 wherein said fractional-word writable architected register comprises a location in a reorder buffer, and further comprising renaming said reorder buffer location by assigning it a GPR identifier.

8. The method of claim 7, wherein said renaming step is performed if said second memory access operation does not cause an exception.

9. The method of claim 8 further comprising removing said GPR identifier from said reorder buffer location if either said memory access operation causes an exception.

10. A processor, comprising:
at least one fractional-word writable architected register; and
an instruction execution pipeline operative to perform two memory access operations to access misaligned data, each said memory access operation writing fractional-word data directly in said fractional-word writable architected register.

11. The processor of claim 10 wherein said instruction execution pipeline is further operative to exception-check both said memory access operations prior to writing the first said fractional-word data to said fractional-word writable architected register.

12. The processor of claim 10 wherein said instruction execution pipeline is further operative to exception-check each said memory access operation.

13. The processor of claim 12 wherein said fractional-word writable architected register comprises a physical register and wherein said physical register is renamed by assigning it a general-purpose register (GPR) identifier.

14. The processor of claim 13, wherein said physical register is renamed if the second said memory access operation does not cause an exception.

15. The processor of claim 13 wherein said physical register renaming is undone if either said memory access operation causes an exception.

16. The processor of claim 12 wherein said fractional-word writable architected register comprises a location in a reorder buffer, and wherein said reorder buffer location is renamed by assigning it a GPR identifier.

17. The processor of claim 16 wherein said reorder buffer location is renamed if the second said memory access operation does not cause an exception.

18. The processor of claim 17 wherein said reorder buffer location renaming is undone if either said memory access operation causes an exception.

19. A method of executing a load instruction directed to data that crosses a predetermined memory boundary, comprising:
obtaining fractional parts of the data from two or more memory access operations directed to respective sides of said boundary; and
independently writing said fractional parts of the data into corresponding fractional portions of the load instruction's destination register.

20. The method of claim 19 further comprising exception-checking all said memory access operations prior to writing the first fractional part of the data to said destination register.

21. The method of claim 19 wherein independently writing said fractional parts of the data into corresponding fractional portions of the load instruction's destination register comprises independently writing said fractional parts of the data into corresponding fractional portions of an available physical register in a register renaming file and assigning an identifier of the load instruction's destination register to the physical register if no exception occurs.

22. The method of claim 21 further comprising exception-checking each said memory access operation as it is performed.

23. The method of claim 19 wherein independently writing said fractional parts of the data into corresponding fractional portions of the load instruction's destination register comprises independently writing said fractional parts of the data into corresponding fractional portions of an available storage location in a reorder buffer and assigning an identifier of the load instruction's destination register to the reorder buffer storage location if no exception occurs.

24. The method of claim 23 further comprising exception-checking each said memory access operation as it is performed.
